(19) United States
(12) Patent Application Publication
(10) Pub. No.: US 2009/0122778 A1
(43) Pub. Date: May 14, 2009

(54) APPARATUS AND METHOD FOR ASSIGNING TIME SLOT FOR TRANSMITTING BEACON IN WIRELESS SENSOR NETWORK

(75) Inventors: Jongyoung Lee, Daejeon-city (KR); Hoon Jeong, Daejeon-city (KR); Jong-Oh Lee, Daejeon-city (KR); Bong Soo Kim, Daejeon-city (KR); Cheol Sig Pyo, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/176,800

(22) Filed: Jul. 21, 2008

(30) Foreign Application Priority Data
Nov. 9, 2007 (KR) 10-2007-0114196

(51) Int. Cl. H04J 3/00

(52) U.S. Cl. 370/345

(57) ABSTRACT

A method and an apparatus for assigning a time slot for transmitting a beacon in a wireless sensor network operated in a beacon mode are provided. In the method and apparatus for assigning a time slot according to the present invention, the total time slots assigned to the network are divided into N blocks and a node to which a time slot is exclusively assigned, among nodes to which a specific node is capable of directly and wirelessly transmitting, is selected as a parent node, the network is divided into two or more regions centering the parent node, a block having the time slot assigned to the parent node and adjacent blocks, among the N blocks, are respectively assigned to the regions, a time slot having been yet unassigned, among the time slots belonging to the block assigned to the region to which the specific node belongs among the divided regions, is assigned as the time slot of the specific node.

### CROSS-REFERENCE TO RELATED PATENT APPLICATION

This application claims the benefit of Korean Patent Application No. 10-2007-0114196, filed on Nov. 9, 2007, in the Korean Intellectual Property Office, the disclosure of which is incorporated herein in its entirety by reference.

### BACKGROUND OF THE INVENTION

1. Field of the Invention

The present invention relates to an apparatus and a method for assigning a time slot for transmitting a beacon by a specific node in a wireless sensor network operated in a beacon mode, to minimize direct or indirect beacons collusion occurring in the beacon mode.

The present invention is derived from a research project supported by the Information Technology (IT) Research & Development (R&D) program of the Ministry of Information and Communication (MIC) and the Institute for Information Technology Advancement (IITA)[2005-S-038-03, UHF RF-ID and Ubiquitous Networking Technology Development].

2. Description of the Related Art

In a wireless sensor network operated in a beacon mode, a node has direct/indirect collisions.

FIG. 1 is a conceptual diagram illustrating an example of a direct collision of a beacon in the conventional art.

Referring to FIG. 1, a circle centering a node ZR1 indicates a region (hereinafter, referred as to a “wireless transmission range” or a “transmission range”) where the node ZR1 can directly transmit a signal wirelessly, and a circle centering a node ZR2 indicates a transmission range of the node ZR2. When nodes generating one or more beacons exist in their ranges and generate the beacons at the almost same time, peripheral nodes do not receive beacon information and then the direct collision occurs. A node N1 cannot receive the beacon information due to the direct collision between the nodes ZR1 and ZR2.

FIG. 2 is a conceptual diagram illustrating an example of an indirect collision of a beacon in the conventional art.

Referring to FIG. 2, when nodes generating two or more beacons transmit the beacons at the almost same time while they do not recognize each other and have an overlapped transmission range, the nodes being within the overlapped transmission range do not receive beacon signals and then the indirect collision occurs. Since the nodes ZR1 and ZR2 have the overlapped transmission range including a node N1, when the nodes ZR1 and ZR2 transmit the beacons to the node N1 at the almost same time, the node N1 cannot receive the beacons due to the indirect collision.

In the relevant conventional methods, a time slot is determined by selecting a representative node called a cluster header in each cluster of a sensor network and exchanging status information with representative nodes of adjacent clusters, or a time slot is determined by dividing location information of each cluster into blocks. However, the conventional methods are based on the assumption that the node called the cluster header generating a beacon is properly located within a predetermined cluster range and only the cluster header generates a beacon signal in the clusters. However, in the actual wireless sensor network, each node is frequently installed or distributed in any location not a predetermined location, and nodes capable of generating a number of beacon signals can be located within one cluster range in a very highly dense environment. Therefore, the conventional methods have the problem of causing the direct/indirect collisions of the beacon mode.

### SUMMARY OF THE INVENTION

The present invention provides an apparatus and a method for assigning a time slot for transmitting a beacon in a wireless sensor network, whereby direct/indirect collisions with peripheral nodes are prevented in the wireless sensor network operated in a beacon mode, to prevent data delay and data retransmission.

According to an aspect of the present invention, there is provided a method for assigning a time slot for transmitting a beacon in a wireless sensor network, comprising: dividing the total time slots assigned to a network into N blocks; selecting a node to which a time slot is exclusively assigned, among nodes to which a specific node belonging to the network is capable of directly transmitting wirelessly, as a parent node; dividing the network into two or more regions centering the parent node, and respectively assigning a block having the time slot assigned to the parent node and adjacent blocks, among the N blocks, to the regions; and assigning a time slot having been yet unassigned, among the time slots belonging to the block assigned to the region to which the specific node belongs among the divided regions, as the time slot of the specific node.

According to another aspect of the present invention, there is provided an apparatus for assigning a time slot for transmitting a beacon in a wireless sensor network, comprising: a parent node selecting unit for selecting a node to which a time slot is exclusively assigned, among nodes to which a specific node to be assigned a present time slot is capable of directly transmitting wirelessly, as a parent node; a block assigning unit for dividing the total time slots assigned to the network to which the specific node belongs, into N blocks, dividing the network into two or more regions centering the parent node, and respectively assigning a block having the time slot assigned to the parent node and adjacent blocks, among the N blocks, to the regions; and a time slot assigning unit for assigning a time slot having been yet unassigned, among the time slots belonging to the block assigned to the region to which the specific node belongs, among the divided regions, as the time slot of the specific node.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram illustrating an example of a direct collision of a beacon in the conventional art;

FIG. 2 is a conceptual diagram illustrating an example of an indirect collision of a beacon in the conventional art;

FIG. 3 is a conceptual diagram illustrating a method of selecting a parent node according to an embodiment of the present invention;

FIG. 4 is a conceptual diagram illustrating a method of deciding a block according to another embodiment of the present invention;

FIG. 5 is a conceptual diagram illustrating a method of deciding a block according to another embodiment of the present invention;

FIG. 6 is a flow chart illustrating a method for assigning a time slot according to another embodiment of the present invention; and

FIG. 7 is a block diagram of an apparatus for assigning a time slot according to another embodiment of the present invention.

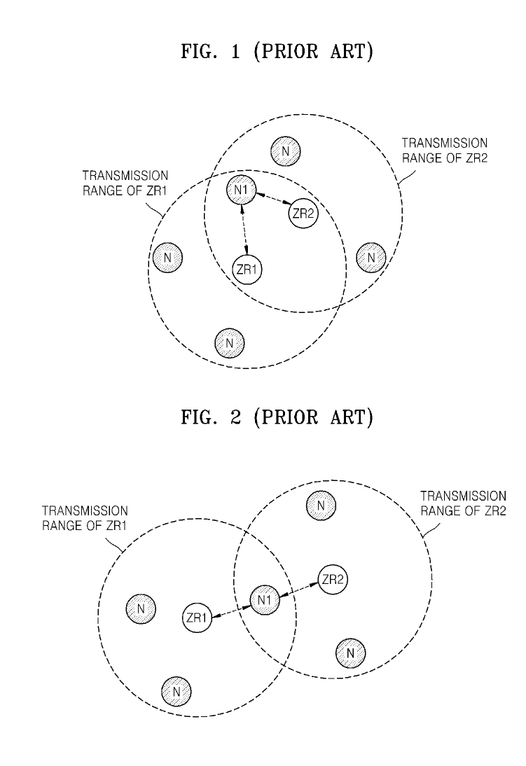

### DETAILED DESCRIPTION OF THE INVENTION

The present invention will now be described more fully hereinafter with reference to the accompanying drawings, in which preferred embodiments of the invention are shown.

A method for assigning a time slot according to an embodiment of the present invention will be sequentially described by steps of: selecting a parent node, deciding a block, and assigning a time slot.

In a wireless sensor network operated in a beacon mode, it is assumed that each node is capable of recognizing information of its own location. After the maximum number N of blocks to be divided from the total time slots available in the wireless sensor network is decided, the sequence of a block to which a time slot assigned to an earliest operating node belongs is designated. Then, the sequence of the block may be designated as 1. Accordingly, all blocks in the wireless sensor network has the sequence of blocks being 1˜N.

As the first step, the selecting of a parent node will be described below:

In the wireless sensor network operated in the beacon mode, each node collects information of the other nodes (hereinafter, referred to as “neighboring nodes”) being within a wireless transmission range. Each node selects its own parent node by using various values of communication quality, distance, time slot and the like, which are included in the information. In the present invention, a node exclusively using an assigned time slot, among the neighboring nodes, is selected as the parent node of each node. This is to prevent a direct collision from occurring when a node having the time slot used by the other neighboring nodes is selected as the parent node.

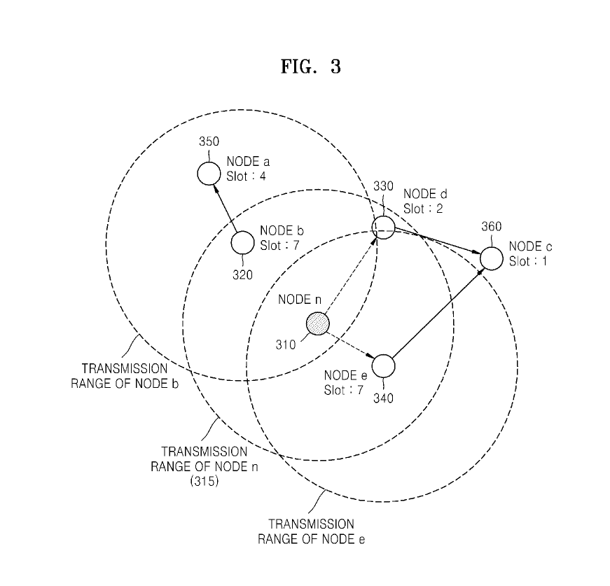

FIG. 3 is a conceptual diagram illustrating a method of selecting the parent node according to an embodiment of the present invention.

Referring to FIG. 3, a wireless sensor network consists of a node a 350, a node b 320, a node c 360, a node d 330, a node e 340 and a node n 310. Slots 4, 7, 1, 2 and 7 are respectively assigned to the nodes a, b, c, d and e. The number given to each slot indicates that the time being assigned to each node is different. Herein, for example, the case is that a time slot shall be assigned to the node n.

Among the nodes b 320, d 330 and e 340 being within a transmission range 315 of the node n, the node b 320 and the node e 340 have the same time slot 7. In this case, when the node b 320 or the node e 340 is selected as the parent node, the indirect collision occurs. Thus, the node d 330 having the only time slot 2 is to be selected as the parent node.

In the deciding of a block as the second step, a node decides its own block by using its own location information and the location information of the parent node. Each of blocks adjacent to the block having the time slot assigned to the parent node is assigned to each of regions divided based on the parent node, so that a specific node belonging to one of the regions is assigned one of the blocks adjacent to the block having the time slot assigned to the parent node.

FIG. 4 is a conceptual diagram illustrating a method of deciding a block according to another embodiment of the present invention.

Referring to FIG. 4, when a parent node is indicated as a node m 410 and a block having a time slot assigned to the parent node is indicated as (P_{block})th block, (P_{block}−2)th block, (P_{block}−1)th block, (P_{block}+1)th block and (P_{block}+2)th block are assigned to the regions to which a node A 420 newly joining in the network belongs. Therefore, the (P_{block}−2)th block is assigned to the region where the node A is located and the (P_{block}+2)th block is assigned to the region where a node B is located. When a calculated value is greater than Blockₘₐₓ or smaller than 1, the sequence of its own block is decided based on a circular method (for example, 1, 2, . . . . Blockₘₐₓ, 1, . . . ), if Blockₘₐₓ is the sequence of the last block of the network. That is, when the sequence of the block to which the parent node belongs is 2 and Blockₘₐₓ is 8, the sequence of the block to which the node A 420 belongs is 8 and the sequence of the block to which the node B 430 belongs is 4.

However, when the parent node and a child node are very close to each other in location, the above method makes a number of blocks to exist in a very narrow space. Therefore, in order for the nodes having the same block value to be located within a certain range, the child node may belong to the same block of the parent node when the distance between the child node and the parent node is less than the certain range.

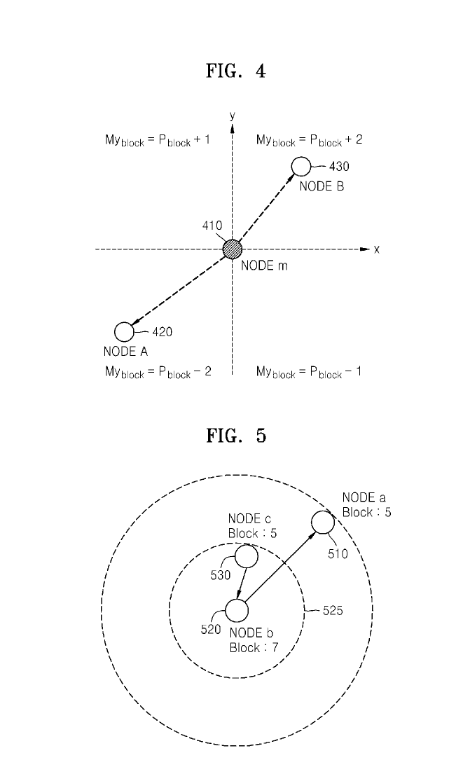

FIG. 5 is a conceptual diagram illustrating a method of deciding a block according to another embodiment of the present invention.

Referring to FIG. 5, according to a block deciding calculation method, a block 5 is assigned to a region where a node c 530 and a node a 510 are located, wherein the node c 530 and the node a 510 have a node b 520 belonging to a block 7 as the parent node. However, when the number of the nodes belonging to the same block in the certain range increases, it increases the probability of direct/indirect collisions of a beacon. Therefore, the node c 530, which belongs to the certain range of the location of the node b 520, for example, a wireless transmission range/2 525, may belong to the block 7, like the node b 520 which is the parent node.

As the final step, the assigning of a time slot will be described below:

When the maximum number of time slots which are usable in the wireless sensor network is indicated as slot_num, the number of time slots included in one block slot_in_block is slot_num/N. Then, when a first time slot number of a specific block having a sequence of k (which is a natural number between 1˜N) is indicated as start_slot and a last time slot number is indicated as end_slot, it is defined that start_slot=slot_in_block*(k−1)+1, end_slot=slot_in_block*k or end_slot=slot_num (when k is N).

Subsequently, after a block of a node is decided, the node sequentially compares the previously collected information of time slots of neighboring nodes with the information of time slots in a calculated block, and decides an unused time slot as its own time slot.

However, in this process, when two nodes being at similar locations are connected to the same parent node, the two nodes belong to the same block and may be assigned the same time slot because they have the same information of neighboring nodes. To prevent this case, the present invention uses a sequence i of connection to the parent node. That is, even though two nodes are connected to the parent node, each of the two nodes has a different connection sequence. Thus, when an address from the parent node is assigned to each node, an address value is differently given. Accordingly, each node can calculate its own connection sequence value, using the address value.

In the present invention, the connection sequence value is used for calculating a value of start_slot. Instead of start_slot=slot_in_block*(k−1)+1 which is used above, start_slot=slot_in_block*(k−1)+1=i is used.

The overall description of a method for assigning a time slot according to the present invention will be as follows:

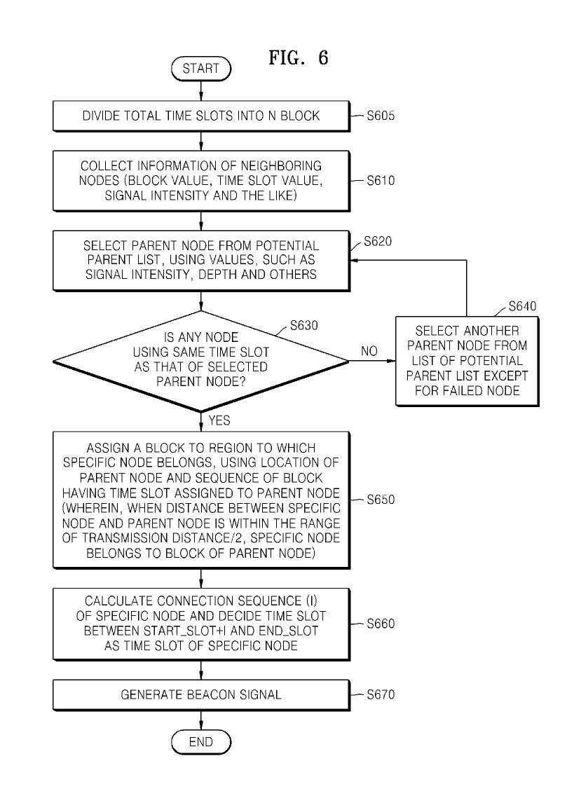

FIG. 6 is a flow chart illustrating a method for assigning a time slot according to another embodiment of the present invention.

Referring to FIG. 6, in step S605, the total time slots usable in a wireless sensor network are divided into N blocks. Subsequently, in step S610, a specific node to newly join in the wireless sensor network collects information (block value, time slot value, signal intensity and the like) of a neighboring node. Subsequently, a potential parent node is selected based on the information. Then, in step S620, a list of appropriate parent nodes based on the information may be made to select the parent node among the list.

When there is a node using the same time slot as a time slot of the selected parent node, the parent node is to be again selected. Then, in step S640, the list of the parent nodes made in step S620 can be used.

After the parent node is selected, a block to be assigned to the region to which the node belongs is decided, by using the location of the parent node and the sequence of the block having the time slot assigned to the parent node. Then, when the node is located within a certain distance from the location of the parent node, for example, within the transmission range/2 of the parent node, in step S650 the node will belong to the same block as that of the parent node.

Subsequently, among the time slots belonging to the block assigned to the region to which a specific node belongs, a time slot having been yet unused is assigned to the specific node. Then, to prevent the same time slot from being assigned to the nodes having the same parent node, in step S660 a sequence i of connection to the parent node is used. In step S670, a beacon signal is generated to the assigned time slot.

An apparatus for assigning a time slot according to the present invention will be described below:

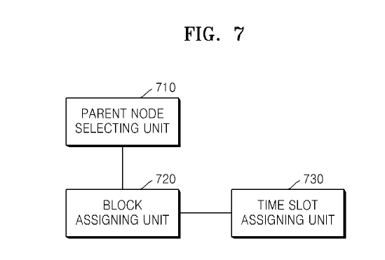

FIG. 7 is a block diagram of an apparatus for assigning a time slot according to another embodiment of the present invention.

Referring to FIG. 7, a parent node selecting unit 710 collects information of neighboring nodes and thereafter selects a parent node by using various values of communication quality, distance, time slot and the like which are included in the information. Then, in the present invention, a node exclusively using an assigned time slot, among the neighboring nodes, is selected as the parent node. This is to prevent an indirect collision occurring when a node having a time slot used by the other neighboring nodes is selected as the parent node.

A block assigning unit 720 defines the maximum number N of blocks for dividing the total time slots available in the wireless sensor network, divides the total time slots into N blocks, and then designates the block sequence for each block. Subsequently, a region of a node is decided by using location information of the parent node and location information of the node. Each of adjacent blocks to the block having a time slot assigned to the parent node are assigned to each of the regions divided based on the parent node, so that a specific node belonging to one of the regions is assigned one of the adjacent blocks to the block having the time slot assigned to the parent node.

Then, after four regions are divided based on the location of the parent node like the method of assigning a time slot, when the sequence of the block having the time slot assigned to the parent node is k, each of the block sequences k−2, k−1, k+1 and k+2 can be assigned to each of the regions.

Further, the block having the time slot assigned to the parent node can be assigned with respect to a certain range from the location of the parent node, for example, to the region of the transmission range/2 of the parent node.

A time slot assigning unit 730 operates as follows: When the maximum number of time slots usable in the wireless sensor network is indicated as slot_num, the number of time slots included in one block slot_in_block is indicated as slot_num/N. Then, when a first time slot number of a specific block having a sequence of k (which is a natural number between 1˜N) is indicated as start_slot and a last time slot number is indicated as end_slot, it is defined that start_slot=slot_in_block*(k−1)+1, end_slot=slot_in_block*k or end_slot=slot_number (when k is N).

Therefore, after the block is decided, the time slot assigning unit 730 sequentially compares the collected time slot information of neighboring nodes, among the time slots from the time slot corresponding to start_slot to the time slot corresponding to end_slot, with the time slot information in the calculated block, and decides an unused time slot as the time slot of the node.

Then, to prevent the time slot from overlapping the time slot of another node having the same parent node and being located at a similar location, it is preferable to consider a sequence i of connection to the parent node. That is, among the time slots from the time slot corresponding to start_slot+i to the time slot corresponding to end_slot, the time slot is assigned.

In accordance with the present invention, direct/indirect beacon collisions are prevented using the location information of each node, so that general data delay in the network and unnecessary energy consumption of each node are prevented, to increase the time of maintaining the network.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for assigning a time slot for transmitting a beacon in a wireless sensor network, comprising:
dividing the total time slots assigned to a network into N blocks;
selecting a node to which a time slot is exclusively assigned, among nodes to which a specific node belonging to the network is capable of directly and wirelessly transmitting, as a parent node;
dividing the network into two or more regions centering the parent node, and respectively assigning a block having the time slot assigned to the parent node and adjacent blocks, among the N blocks, to the regions; and
assigning a time slot having been yet unassigned, among the time slots belonging to the block assigned to the region to which the specific node among the divided regions, as a time slot of the specific node.

2. The method of claim 1, wherein the assigning the block comprises:
when a sequence of the block having the time slot assigned to the parent node is k, assigning a (k−2)th block to a region at the left bottom portion in a location of the parent node, a (k−1)th block to a region at the right bottom portion, a (k+1)th block to a region at the right top portion, and a (k+2)th block to the left top portion.

3. The method of claim 1, wherein the assigning the block assigns the block having the time slot assigned to the parent node to a region within a certain distance from the location of the parent node.

4. The method of claim 1, wherein the assigning the time slot assigns a time slot having been yet unassigned, among the time slots from a time slot corresponding to a sequence of connection to the parent node to a time slot corresponding to a last sequence, among the time slots belonging to the block assigned to the region to which the specific node belongs, as the time slot of the specific node.

5. An apparatus for assigning a time slot for transmitting a beacon in a wireless sensor network, comprising:
a parent node selecting unit for selecting a node to which a time slot is exclusively assigned, among nodes to which a specific node to be a present time slot is capable of directly and wirelessly transmitting, as a parent node;
a block assigning unit for dividing the total time slots assigned to a network to which the specific node belongs into N blocks, subsequently dividing the network into two or more regions centering the parent node, and respectively assigning a block having the time slot assigned to the parent node and adjacent blocks, among the N blocks, to the regions; and
a time slot assigning unit for assigning a time slot having been yet unassigned, among the time slots belonging to the block assigned to the region to which the specific node belongs among the divided regions, as a time slot of the specific node.

6. The apparatus of claim 5, wherein, when a sequence of the block having the time slot assigned to the parent node is k, the block assigning unit assigns a (k−2)th block to a region at the left bottom portion in a location of the parent node, a (k−1)th block to a region at the right bottom portion, a (k+1)th block to a region at the right top portion, and a (k+2)th block to the left top portion.

7. The apparatus of claim 5, wherein the block assigning unit assigns the block having the time slot assigned to the parent node, to a region within a certain distance from the location of the parent node.

8. The apparatus of claim 5, wherein the time slot assigning unit assigns a time slot having been yet unassigned, among the time slots from a time slot corresponding to a sequence of connection to the parent node to a time slot corresponding to a last sequence, among the time slots belonging to the block assigned to the region to which the specific node belongs, as the time slot of the specific node.
